(19) United States
(12) Patent Application Publication
(10) Pub. No.: US 2026/0366705 A1
(43) Pub. Date: Nov. 19, 2026

(54) Lamp Holder with External Spiral Thread Around Light Socket Housing for Lampshade Attachment

(71) Applicant: Juan Manuel Surillo Dahdah, Mayagüez, PR (US)

(72) Inventor: Juan Manuel Surillo Dahdah, Mayagüez, PR (US)

(21) Appl. No.: 19/208,568

(22) Filed: May 14, 2025

(51) Int. Cl. F21V 17/06; F21V 1/02; F21V 15/01; F21V 17/00; F21V 23/06

(52) U.S. Cl. CPC F21V 17/06; F21V 1/02; F21V 15/01; F21V 17/002; F21V 23/06

(57) ABSTRACT

The present application discloses a lamp holder apparatus comprising a lamp holder body with a light bulb socket housing configured to encase a light bulb socket, comprising an external spiral thread on the outer surface of the light bulb socket housing. The spiral thread enables the attachment of a lampshade from the exterior without requiring removal or replacement of the lamp holder, providing a simplified and reusable method for replacing and securing lampshades.

### BACKGROUND OF THE INVENTION

The present disclosure relates to lamp holders, more particularly, to lamp holders that allow for easy mount and dismount of lamp shades, everyday appliances such as fans, chandeliers, light fixtures and others.

Common lamp holders are typically removed in order to set up the ceiling or wall appliance base that is desired. Removing said common lamp holder and installing the desired appliance base usually involves the use or overuse of power tools such as power drills. This can cause damage to the walls or ceiling of a structure.

Many homeowners may find the task of changing or adding lamp holders and/or other light fixtures daunting because of the amount of work they must do to install them, or the amount of money needed to hire a professional to do said work. The invention in the present application looks to solve this problem by providing a solution that only needs to be installed once and can allow to easily change appliances, fixtures or lamp shades.

Conventional lamp holders typically secure lampshades using internal clips, harp assemblies, or fixed mounts that require disassembly or replacement of the holder to change the shade. These methods can be inconvenient, often requiring additional tools or limiting shade compatibility. There exists a need for a lamp holder that facilitates easy, external and functional lampshade, or other fixtures, switching and replacement. This can be done by directly modifying the functionality of the lamp holder without altering the holder's structure or having to change the whole electric fixture as a whole.

### SUMMARY

Embodiments of the present invention disclose a product comprising of a lamp holder which in turn is comprised of a base portion, wherein a cylindrical housing for a light bulb socket with a spiral threaded exterior surface threading around said cylindrical housing for a light bulb socket is attached to the center of said base portion. Wherein a lightbulb socket is housed inside said cylindrical housing for a lightbulb socket. And a cylindrical piece comprising a smooth outer exterior and a threaded interior is utilized to attach different styles, shapes and designs of lampshades or other attachments. Said lampshades or other attachments are attached to said cylindrical piece, which in turn is attached to the lamp holder by engaging the spiral threaded interior of said cylindrical piece with the spiral threaded exterior of said cylindrical housing for a light bulb socket attached to said lamp holder.

### BRIEF DESCRIPTION OF THE DRAWINGS

The accompanying drawings, which are incorporated herein, constitute part of the specifications and illustrate the preferred embodiment of a lamp holder with an external spiral threading around the light socket housing for the attachment of a lamp shade, a fixture or other.

FIG. 1 presents a fully expanded view of an exemplary embodiment of the invention with a lamp shade base.

FIG. 2 shows a partially expanded view of the invention with a lamp shade base.

FIG. 3 presents an exemplary embodiment of the of the invention with a lamp shade base.

FIG. 4 presents a fully expanded view of an exemplary embodiment of the invention, without a lamp shade base, where the lamp shade is directly attached to the cylindrical piece.

FIG. 5 shows a partially expanded view of the invention, without a lamp shade base, where the lamp shade is directly attached to the cylindrical piece.

FIG. 6 presents an exemplary embodiment of the invention, without a lamp shade base, where the lamp shade is directly attached to the cylindrical piece.

### DETAILED DESCRIPTION

The common lamp holder, currently available to the public, is one of a simple design that, given its simplicity, is extremely limited to only holding a light bulb, but not a lamp shade, a light fixture or other appliances.

Detailed descriptions of one or more of the preferred embodiments are provided herein. It is to be understood, however, that the present disclosure may be embodied in various forms. Therefore, specific details disclosed herein are not to be interpreted as limiting, but rather as a basis for the claims and as a representative basis for teaching one skilled in the art to employ the present invention in any appropriate system, structure, or manner.

The invention claimed in the present application possesses a spiral threading formed with a pitch that allows for a secure and stable connection between the lamp holder and the lamp shade or light fixture while enabling ease of attachment and detachment by hand.

The invention claimed in the present application possesses a base portion made of plastic, carbon fiber, fiberglass, or any other kind of durable and moldable material, providing durability and electrical insulation for safe operation.

The common lamp holder does not possess a threaded pitched external spiral. Meaning that no possible lamp shade or fixture can be attached to it. This means that said common lamp holder must be removed in order to install a base capable of attaching to the desired lamp shade or fixture. The present invention solves that problem by providing a lamp holder with said threaded pitched external spiral and a cylindrical piece with a threaded pitched interior spiral, allowing for said cylindrical piece to be tightened upon said threaded pitched external spiral for easy installation and loosened for easy removal.

The invention claimed in the present application possesses a base portion which includes a central opening configured to receive an electrical connection for powering a light fixture or light bulb attached to the lamp holder.

The invention claimed in the present application possesses a system for attaching a lamp shade, fixture, or other alternative, to a lamp holder. Said invention claimed the the present application is comprised of: a lamp holder as described in the present application containing a cylindrical housing for the light bulb socket with a threaded exterior; a cylindrical piece with a threaded interior attached to a lamp shade or a fixture having said threaded interior configured to engage said exterior spiral threading of said cylindrical housing for the light bulb socket on the lamp holder. Wherein the lamp shade or fixture can be securely attached or detached from the lamp holder by rotating said lamp shade or fixture onto or off of the spiral threading. Said cylindrical piece may also be attached directly to the lamp shade itself.

The size, design and shape of the invention described in the current application can be modified for user convenience and to fit different types of styles of lamp shades, fixtures or appliances.

An exemplary embodiment of the claimed invention in the present application is a lamp holder comprising a base portion with a circular hole on the left side of the base portion and a circular hole on the right side of the base portion. It also comprises a cylindrical housing for a light bulb socket with a spiral threaded exterior surface threading around said cylindrical housing for a light bulb socket in the center of the base portion. It also comprises a lightbulb socket housed inside said cylindrical housing for a light bulb socket. It also comprises a cylindrical piece with a smooth outer exterior and a threaded pitched interior spiral that can be twisted on to, or off of, said cylindrical housing for a light bulb socket. It also comprises, but is not limited to, a lamp shade base which is comprised mainly of an inner ring attached to the smooth outer exterior of said cylindrical piece. Said lamp shade can vary in style, size and shape to be attached to the base. Wherein the spiral threaded exterior surface threading around said cylindrical housing for a light bulb socket in the center of the base portion is configured to securely attach and detach a lamp shade or light fixture by twisting the lamp shade or light fixture onto or off of the base portion.

Another exemplary embodiment of the claimed invention in the present application is a lamp holder comprising a base portion with a circular hole on the left side of the base portion and a circular hole on the right side of the base portion. It also comprises a cylindrical housing for a light bulb socket with a spiral threaded exterior surface threading around said cylindrical housing for a light bulb socket in the center of the base portion. It also comprises a lightbulb socket housed inside said cylindrical housing for a light bulb socket. It also comprises a cylindrical piece with a smooth outer exterior and a threaded pitched interior spiral that can be twisted on to, or off of, said cylindrical housing for a light bulb socket. It also comprises, but is not limited to, a lamp shade attached to the smooth outer exterior of said cylindrical piece. Said lamp shade can vary in style, size and shape to be attached to the cylindrical piece. Wherein the spiral threaded exterior surface threading around said cylindrical housing for a light bulb socket in the center of the base portion is configured to securely attach and detach a lamp shade or light fixture by twisting the lamp shade or light fixture onto or off of the base portion.

Another exemplary embodiment of the invention as described in the present application is a lamp holder comprising a base portion, wherein a cylindrical housing for a light bulb socket with a spiral threaded exterior surface threading around said cylindrical housing for a light bulb socket is attached to the center of said base portion, wherein a lightbulb socket is housed inside said cylindrical housing for a light bulb socket; a cylindrical piece comprising a smooth outer exterior and a threaded interior; a lamp shade base comprising an inner ring which is attached to said smooth outer exterior of said cylindrical piece, wherein said lamp shade base comprising a plurality of rods, evenly spaced, attached on one end to said inner ring and on the other end to an outer base portion which can vary in size and shape to be attached to a plurality of lamp shades; said lamp shade base is attached to the smooth outer exterior of said cylindrical piece; said cylindrical piece can be attached or detached from the lamp holder by engaging said spiral threaded interior of said cylindrical piece with said spiral threaded exterior surface around said cylindrical housing for a light bulb socket by twisting said cylindrical piece onto or off of said spiral threaded exterior surface threading around said cylindrical housing for a light bulb socket.

Another exemplary embodiment of the invention as described in the present application is a lamp holder comprising a base portion, wherein a cylindrical housing for a light bulb socket with a spiral threaded exterior surface threading around said cylindrical housing for a light bulb socket is attached to the center of said base portion, wherein a lightbulb socket is housed inside said cylindrical housing for a light bulb socket; a cylindrical piece comprising a smooth outer exterior and a threaded interior, wherein a lamp shade comprising an opening is attached to said smooth outer exterior of said cylindrical piece, wherein said lamp shade can vary in size and shape; said cylindrical piece can be attached or detached from the lamp holder by engaging said spiral threaded interior of said cylindrical piece with said spiral threaded exterior surface around said cylindrical housing for a light bulb socket by twisting said cylindrical piece onto or off of said spiral threaded exterior surface threading around said cylindrical housing for a light bulb socket.

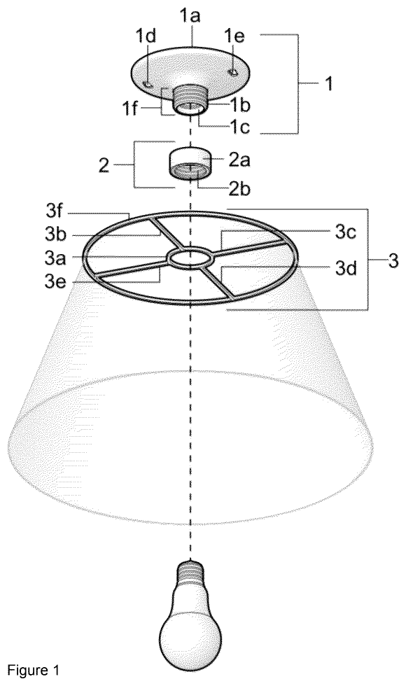

FIG. 1 shows a fully expanded view of an exemplary embodiment of the claimed invention. The invention constructed in accordance with this application comprises three bodies. Said invention being a lamp holder, comprising a base portion 1, a cylindrical piece 2, and a lamp shade base 3. Said base portion 1 comprises a main body 1a, a cylindrical housing for a light bulb socket 1f with a spiral threaded exterior surface 1b threading around said cylindrical housing for a light bulb socket 1f, and a lightbulb socket 1c housed inside said cylindrical housing for a light bulb socket 1f. Said cylindrical piece 2 comprises a smooth outer exterior 2a and a threaded interior 2b. Said lamp shade base 3 comprises an inner ring 3a comprising a plurality of rods 3b, 3c, 3d, 3e evenly spaced attached on one end to the inner ring 3a and on the other end to the outer base portion 3f, which can vary in size and shape to be attached to a plurality of lamp shades. Said main body 1a of said base portion 1 also comprises, but is not limited to, a circular hole 1d on the left side of the main body 1a and a circular hole le on the right side of the main body 1a.

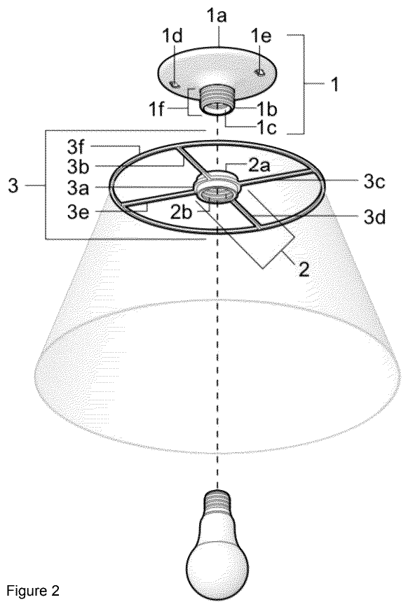

FIG. 2 shows a partially expanded view of an exemplary embodiment of the claimed invention. That being a lamp holder, comprising a base portion 1, a cylindrical piece 2, and a lamp shade base 3 attached to said cylindrical piece 2. Said base portion 1 comprises a main body 1a, a cylindrical housing for a light bulb socket 1f with a spiral threaded exterior surface 1b threading around said cylindrical housing for a light bulb socket 1f, and a lightbulb socket 1c housed inside said cylindrical housing for a light bulb socket 1f. Said cylindrical piece 2 comprises a smooth outer exterior 2a and a threaded interior 2b. Said lamp shade base 3 comprises an inner ring 3a comprising a plurality of rods 3b, 3c, 3d, 3e evenly spaced attached on one end to the inner ring 3a and on the other end to the outer base portion 3f, which can vary in size and shape to be attached to a plurality of lamp shades. Said inner ring 3a of said lamp shade base 3 is attached to said smooth outer exterior 2a of said cylindrical piece 2 so that said lamp shade base 3 does not fall out of place. Said main body 1a of said base portion 1 also comprises, but is not limited to, a circular hole 1d on the left side of the main body 1a and a circular hole le on the right side of the main body 1a.

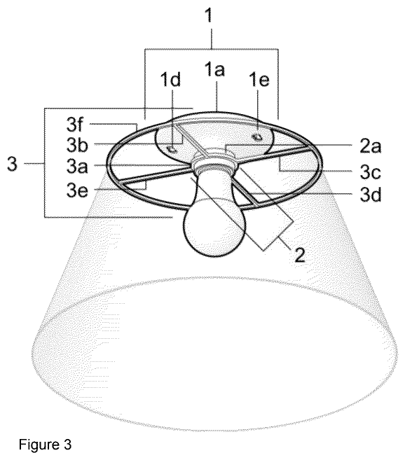

FIG. 3 shows an assembled view of an exemplary embodiment of the claimed invention attaching all three bodies of the claimed invention. That being a lamp holder, comprising a base portion 1, a cylindrical piece 2 attached to said base portion 1, and a lamp shade base 3 attached to said cylindrical piece 2. Said base portion 1 comprises a main body 1a. Said cylindrical piece 2 comprises a smooth outer exterior 2a. Said cylindrical piece 2 is attached to said main body la of said base portion 1. Said lamp shade base 3 comprises an inner ring 3a comprising a plurality of rods 3b, 3c, 3d, 3e evenly spaced attached on one end to the inner ring 3a and on the other end to the outer base portion 3f, which can vary in size and shape to be attached to a plurality of lamp shades. Said inner ring 3a of said lamp shade base 3 is attached to said smooth outer exterior 2a of said cylindrical piece 2 so that said lamp shade base 3 does not fall out of place. Said main body la of said base portion 1 also comprises, but is not limited to, a circular hole 1d on the left side of the main body 1a and a circular hole le on the right side of the main body 1a.

The way said cylindrical piece 2 is attached to said base portion 1 of the claimed invention is by engaging the spiral threaded interior 2b of said cylindrical piece 2 with the spiral threaded exterior 1b of said cylindrical housing for a light bulb socket 1f of said lamp holder base 1.

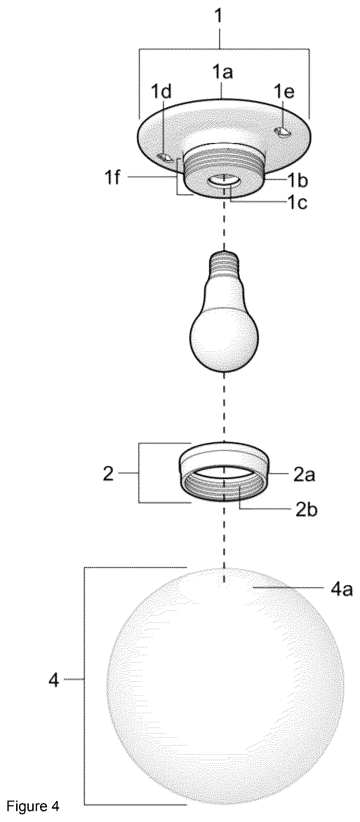

FIG. 4 shows a fully expanded view of an exemplary embodiment of the claimed invention. The invention constructed in accordance with this application comprises three bodies. Said invention being a lamp holder, comprising a base portion 1, a cylindrical piece 2, and a lamp shade 4. Said base portion 1 comprises a main body 1a, a cylindrical housing for a light bulb socket If with a spiral threaded exterior surface 1b threading around said cylindrical housing for a light bulb socket 1f, and a lightbulb socket 1c housed inside said cylindrical housing for a light bulb socket 1f. Said cylindrical piece 2 comprises a smooth outer exterior 2a and a threaded interior 2b. Said lamp shade 4 comprises an opening 4a. Said lamp shade 4 can vary in size and shape to accommodate the preference of design of the user. Said main body 1a of said base portion 1 also comprises, but is not limited to, a circular hole 1d on the left side of the main body 1a and a circular hole le on the right side of the main body 1a.

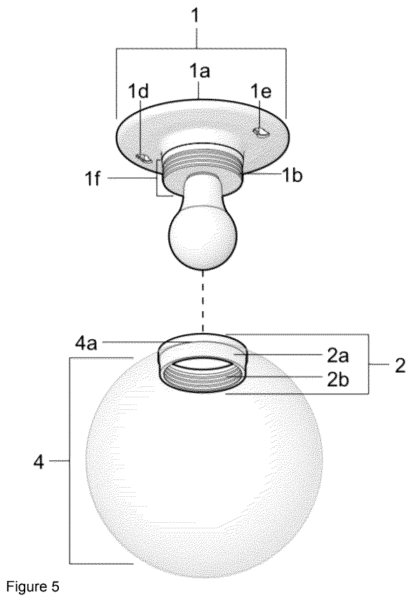

FIG. 5 shows a partially expanded view of an exemplary embodiment of the claimed invention. That being a lamp holder, comprising a base portion 1, a cylindrical piece 2, and a lamp shade 4 attached to said cylindrical piece 2. Said base portion 1 comprises a main body 1a, a cylindrical housing for a light bulb socket 1f with a spiral threaded exterior surface 1b threading around said cylindrical housing for a light bulb socket 1f. Said cylindrical piece 2 comprises a smooth outer exterior 2a and a threaded interior 2b. Said lamp shade 4 comprises an opening 4a. Said opening 4a of said lamp shade 4 is attached to said smooth outer exterior 2a of said cylindrical piece 2 so that said lamp shade 4 does not fall out of place. Said lamp shade 4 can vary in size and shape to accommodate the preference of design of the user. Said main body 1a of said base portion 1 also comprises, but is not limited to, a circular hole 1d on the left side of the main body 1a and a circular hole le on the right side of the main body 1a.

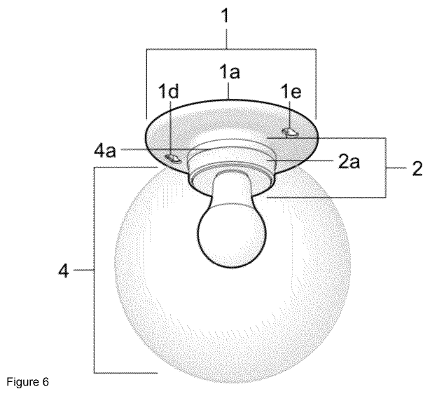

FIG. 6 shows an assembled view of an exemplary embodiment of the claimed invention attaching all three bodies of the claimed invention. That being a lamp holder, comprising a base portion 1, a cylindrical piece 2 attached to said base portion 1, and a lamp shade 4 attached to said cylindrical piece 2. Said base portion 1 comprises a main body 1a. Said cylindrical piece 2 comprises a smooth outer exterior 2a. Said cylindrical piece 2 is attached to said main body 1a of said base portion 1. Said lamp shade 4 comprises an opening 4a. Said opening 4a of said lamp shade 4 is attached to said smooth outer exterior 2a of said cylindrical piece 2 so that said lamp shade 4 does not fall out of place. Said lamp shade 4 can vary in size and shape to accommodate the preference of design of the user. Said main body 1a of said base portion 1 also comprises, but is not limited to, a circular hole 1d on the left side of the main body 1a and a circular hole 1e on the right side of the main body 1a.

The way said cylindrical piece 2 is attached to said base portion 1 of the claimed invention is by engaging the spiral threaded interior 2b of said cylindrical piece 2 with the spiral threaded exterior 1b of said cylindrical housing for a light bulb socket 1f of said lamp holder base 1.

1. A lamp holder comprising:
a base portion;
wherein a cylindrical housing for a light bulb socket with a spiral threaded exterior surface threading around said cylindrical housing for a light bulb socket is attached to the center of said base portion; and
wherein a lightbulb socket is housed inside said cylindrical housing for a light bulb socket.

2. The lamp holder of claim 1, further comprising a cylindrical piece comprising a smooth outer exterior and a threaded interior.

3. The lamp holder of claim 2, further comprising a lamp shade base, wherein said lamp shade base comprises an inner ring attached to said smooth outer exterior of said cylindrical piece, and a plurality of rods evenly spaced and attached on one end to said inner ring and on the other end to an outer base portion to be attached to a plurality of lamp shades.

4. The lamp holder of claim 2, wherein a lamp shade is directly attached to said cylindrical piece.

5. The lamp holder of claim 1, and wherein said spiral threaded exterior surface is configured to securely attach and detach a lamp shade or light fixture by twisting the lamp shade or light fixture onto or off of the base portion.

6. The lamp holder of claim 2, and wherein said cylindrical piece is configured to be attached to or detached from the lamp holder by engaging said threaded interior of said cylindrical piece with said spiral threaded exterior surface around said cylindrical housing for a light bulb socket.

7. The lamp holder of claim 1, wherein the base portion comprises a central opening configured to receive an electrical connection for powering a light fixture or light bulb attached to the lamp holder.

8. The lamp holder of claim 1, wherein the base portion is made of plastic, carbon fiber, fiberglass, metal or any other kind of durable and moldable material, providing durability and electrical insulation for safe operation.

9. The lamp holder of claim 2, wherein said cylindrical piece is made of plastic, carbon fiber, fiberglass, metal or any other kind of durable and moldable material, providing durability and electrical insulation for safe operation.

10. The lamp holder of claim 3, wherein said lamp shade base is made of plastic, carbon fiber, fiberglass, metal or any other kind of durable and moldable material, providing durability.
